(19) United States
(12) Patent Application Publication
(10) Pub. No.: US 2013/0112064 A1
(43) Pub. Date: May 9, 2013

(54) Can or Bottle Opener for Adjusting Drum Hardware and Related Methods of Use

(71) Applicant: Jason Ginter, San Diego, CA (US)

(72) Inventor: Jason Ginter, San Diego, CA (US)

(21) Appl. No.: 13/292,061

(22) Filed: Nov. 8, 2011

(51) Int. Cl. G10G 7/00

(52) U.S. Cl. 84/458

(57) ABSTRACT

Disclosed may be a multi-tasking drum key and related methods. In one non-limiting embodiment, the drum key has a wrench with a pivot shaft extending therefrom, a handle that forms an elbow with the pivot shaft, wherein the handle has at least one twisted surface, and a lever and tooth on the elbow. Operably, the handle may be used to either (1) turn the wrench about the shaft or (2) pivot the lever on a fulcrum.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

1. Field of Invention.

This application is in the fields of can or bottle openers that may be used for drum hardware tuning, tensioning, or positioning.

2. Background.

Drums are a known type of musical instrument. Structurally, drums frequently comprise a membrane, known colloquially as the “drum head,” which membrane is typically stretched and held taut over the rim of a hollow cylindrical shell. A means for holding the membrane taut may be a hoop or ring made of metal or wood that couples with the rim of the shell. The ring is normally coupled to the rim of the shell, via tension rods which are usually screwed into threaded lugs around the rim, so that the drum head is clamped and held taut between the rim and the hoop.

Operably, striking a taut drum head with a hand or mallet will result in vibrations within the frequencies of human hearing (i.e., sound). Frequently, a drum membrane may lose its tautness or require replacement for optimum sound. In either circumstance the drum head may not be suitable for operation and, as a result, the engagement of the lugs and tension rods may need to be (1) loosened so that the membrane can be adjusted or replaced and (2) tightened so that the membrane or its replacement can be held taut as described above. In many instances, the rods are screwly loosened or tightened from the lugs with a small wrench, known colloquially as a “drum key,” in a manner that is well known for coupling a nut and bolt.

A drum key may be used for more than loosening and tightening the tautness of a membrane. For example, a drum key may be used to loosen or tighten a set screw so that the orientation or position of a drum in a drum kit may be adjusted. Accordingly, drum musicians or technicians are frequently desirous of carrying a drum key on their person. As a result drum keys are frequently placed on a key ring/chain and carried in-pocket by drum musicians or technicians.

Known drum keys, while capable of loosening and tightening screws or tension rods, are not optimally configured for being carried in-pocket on a key ring. One suboptimal aspect is that drum keys are frequently defined by an elbowed structure so that the drum keys are usually uncomfortably out of plane (i.e., do not lie flat) with the other keys or tools on a key ring when placed in-pocket. Certainly, unelbowed drum keys are known which would lay flat in-pocket on a key ring, but such unelbowed drum keys are too unsatisfactory since they operably result in less torque while turning screws than do elbowed drum keys. As a result, there is a need for elbowed drum keys that can be comfortably stored in-pocket on a key-chain.

Known elbowed drum key configurations are further suboptimal since drum keys are only configured to turn tension rods or screws for tautening a drum head. Said limited configuration is suboptimal since drum technicians and musicians cannot use a drum key for multiple tasks. For instance, many drum musicians or technicians are desirous of eating or drinking canned or bottled foodstuffs or beverages before, during, or after tautening or replacing a drum head, but will be unable to satisfy their desires with known drum keys which are not adequately configured for opening bottles or cans. Accordingly, there is a need for drum keys which are configured for multiple tasks.

### SUMMARY OF THE INVENTION

In view of the foregoing, it is an object of this application to disclose a drum key that is configured (1) for multiple tasks and/or (2) to lay substantially flat while in-pocket on a key ring. In one non-limiting embodiment, the drum key may comprise: a wrench with a pivot shaft extending therefrom; a handle that forms an elbow with the pivot shaft, wherein the handle has at least one twisted surface; and a lever and tooth on the elbow. Operably, the handle may be used to either (1) turn the wrench about said shaft or (2) pivot the lever on a fulcrum.

It is a further objective of this application to provide previously unrealized methods of using a drum key not only for purposes of tuning a drum, but also to assist in opening a beverage to quenching one's thirst. For instance, one method may comprise the step of using a drum key as a lever to open a beverage. Another method may comprise the steps of: locating a wrench with a pivot shaft that is coupled to a handle in the form of an elbow, wherein the handle has a lever extending from the elbow and the pivot shaft has a tooth beneath the lever; locating a drum with a frame, a first tension rod, a second tension rod, a first lug on the frame, and a second lug on the frame; locating a bottled beverage with a lipped cap; turning the wrench about the pivot shaft via the handle to screw the first tension rod into the first lug on the drum frame; positioning the tooth beneath the lip of the bottle cap and pivoting the lever on a fulcrum via the handle to remove the cap; and, turning the wrench about the pivot shaft via the handle to screw the second tension rod into the second lug on the drum frame.

### BRIEF DESCRIPTION OF THE FIGURES

The manner in which these objectives and other desirable characteristics can be obtained is better explained in the following description and attached figures in which:

FIG. 1 is a perspective view of a multi-task drum key;

FIG. 2 is a top view of the multi-task drum key of FIG. 1;

FIG. 3 is a bottom view of the multi-tasking drum key of FIG. 1;

FIG. 4 is a left side view of the multi-task drum key of FIG. 1;

FIG. 5 is a right side view of the multi-task drum key of FIG. 1;

FIG. 6 is a rear view of the multi-task drum key of FIG. 1;

FIG. 7 is a front view of the multi-task drum key of FIG. 1; and,

FIG. 8 is an environmental view of the drum key of FIG. 1 being used to open a bottle.

It is to be noted, however, that the appended figures illustrate only a typical embodiment of a multi-tasking drum key. As a result, the figures are not to be considered limiting of the scope of the underlying invention. That is to say, the disclosed invention may admit to other equally effective embodiments that will be appreciated by those reasonably skilled in the relevant arts.

### DETAILED DESCRIPTION OF PREFFERED EMBODIMENTS

What is disclosed by this specification may be a drum key that is configured (1) to lay flat while in-pocket on a key ring and/or (2) for can or bottle opening. Generally, the drum key may feature: a socket wrench at the end of a pivot shaft; a handle that forms an elbow with the shaft at the opposite end from the socket wrench; a lever and tooth on the outside of the elbow; and, wherein the handle is flat and twisted so that a first portion and a second portion of the handle are perpendicular to one another. Operably, the handle of the drum key may be used to either (1) turn the wrench about said shaft or (2) pivot the lever on a fulcrum.

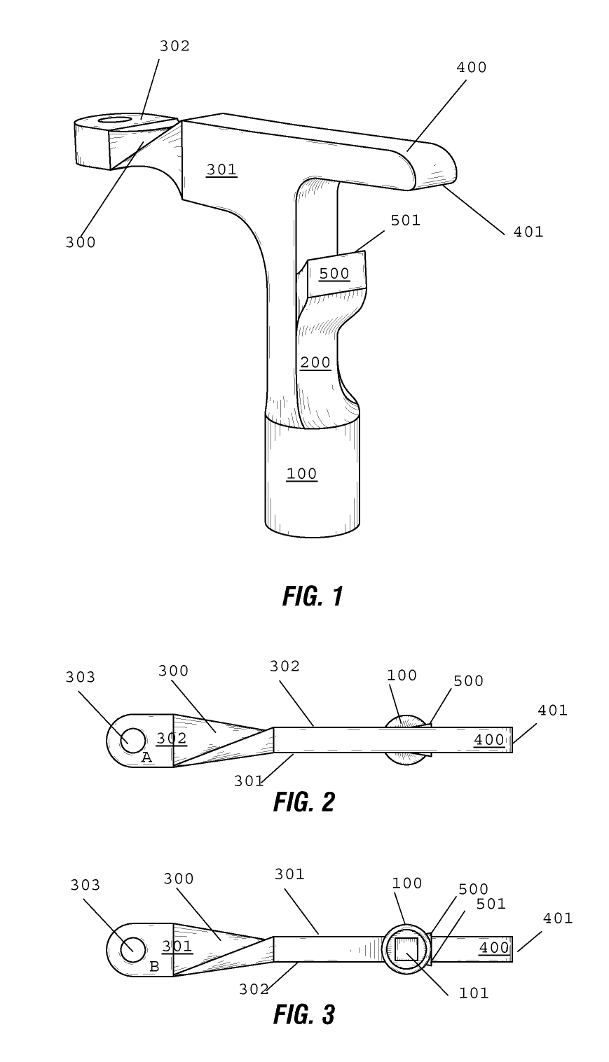

FIG. 1 is a perspective view of a preferable embodiment of a multi-task drum key 1. FIGS. 2 through 7 correspondingly depict the top, bottom, left side, right side, rear, and front views of the multi-task drum key 1 of FIG. 1. As seen in the figures, the drum key features a wrench 100, a pivot shaft 200, a handle 300, a lever 400, and a tooth 500.

The specific details of the wrench 100 are best disclosed with reference to FIGS. 1, 3, and 4. As seen in those figures, the wrench 100 may feature a socket 101 (FIG. 3) (e.g., may be a socket wrench) that is adapted to fit over one end of a nut or bolt head. Operably, the wrench 100 may receive a nut or bolt and be pivoted so that the wrench correspondingly turns the nut or bolt about an axis. As shown, the socket 101 is preferably defined by a four-point recess that it is adapted to receive and fit over a nut or bolt with a square head. However, it should be noted that in other embodiments of the socket 101 may be defined by a six, eight, or twelve-point recess for receiving nuts or screws of various configurations. Furthermore, it is not necessary that the wrench 100 be a socket wrench as any type of wrench that operates by turning on an axis may be provided without departing from the spirit and intent of this invention. For example, an Allen wrench head, torx wrench head, Phillips screw driver head, or flat screwdriver head may be provided so that the wrench's 100 head inserts into a corresponding socket on a bolt or screw.

The specific details of the pivot shaft 200 are best disclosed with reference to FIGS. 1 and 4 through 7. Referring to those figures, the pivot shaft 200 is an elongated member extending from the wrench 100 about which the wrench may be turned. The primary purpose of the pivot shaft is to provide a mechanical connection between the handle 300 and the wrench.

The specific details of the handle 300 are best disclosed with reference to FIGS. 1 through 5. Structurally, the handle 300 is an elongated and flat strip of material that is coupled to the pivot shaft to form an elbow. In the preferable embodiment depicted in the figures, the handle 300 is defined by a strip of material with two substantially parallel surfaces 301 and 302. In the figures, the handle 300 is twisted so that: (1) a plane A of a portion of one surface 301 is oriented perpendicular to another plane B of another portion of the surface 301; and (2) a plane C of a portion of the other surface 302 is oriented perpendicular to another plane D of another portion of the other surface 302. Operably, the handle 300 may be used to turn or torque the wrench 100 about the pivot shaft 200.

Referring to FIGS. 2 and 3, the handle 300 may feature an aperture 303 for coupling the drum key 1 to a key ring (not depicted). When coupled to a key ring (not depicted) via the aperture 303, the twisted configuration of the handle 300 allows the key ring to fold together with the handle so that the key ring and drum key may lay substantially flat when in-pocket.

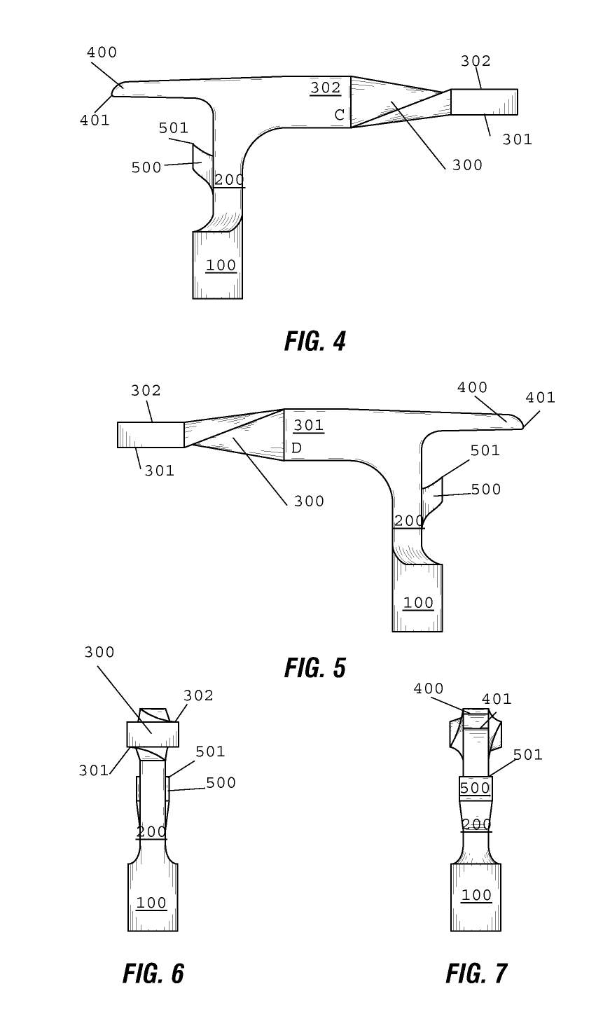

The specific details of the lever 400 and tooth 500 are best disclosed with reference to FIGS. 1, 4, 5, and 7. Referring first to FIGS. 4 and 5, the lever 400 is an elongated member that extends from the elbow of the pivot shaft 200 and the handle 300 so that the handle 300, lever 400, and pivot shaft 200 generally form a T-shaped structure. Referring still to FIGS. 4 and 5, the tooth 500 is generally an edged surface that extends briefly from the pivot shaft 200 between the lever and the wrench 100. Operably, the lever 400 may be pivoted on a fulcrum 401 via the handle 300, wherein the tooth 500 may be correspondingly forced in the pivot direction. Referring now to FIG. 7, the edge 501 of the tooth 500 is generally perpendicular to the lever 400 so that the tooth 500 has a griping function whenever the lever is pivoted about the fulcrum 401. This said, the tooth 500 may be elongated with the edge 501 parallel to the lever so that the tooth has a cutting function (e.g., in the manner of a lever type can-opener) instead of a gripping function.

Referring now to FIGS. 1 through 7, the depicted drum key 1 may be (1) formed of any materials suitable for turning screws and opening bottles or cans and (2) formed by any suitable processes. In a preferable embodiment, the drum key 1 is formed of stainless steel in a single unit by molding. This said: any material, including but not limited to metals, plastics, woods, or ceramics, may be used to construct disclosed drum key 1; and, any process, including cutting or molding, may be used to form the drum key 1 in a unit. Additionally, each component of the drum key 1 may be formed separately of the same or different materials and assembled.

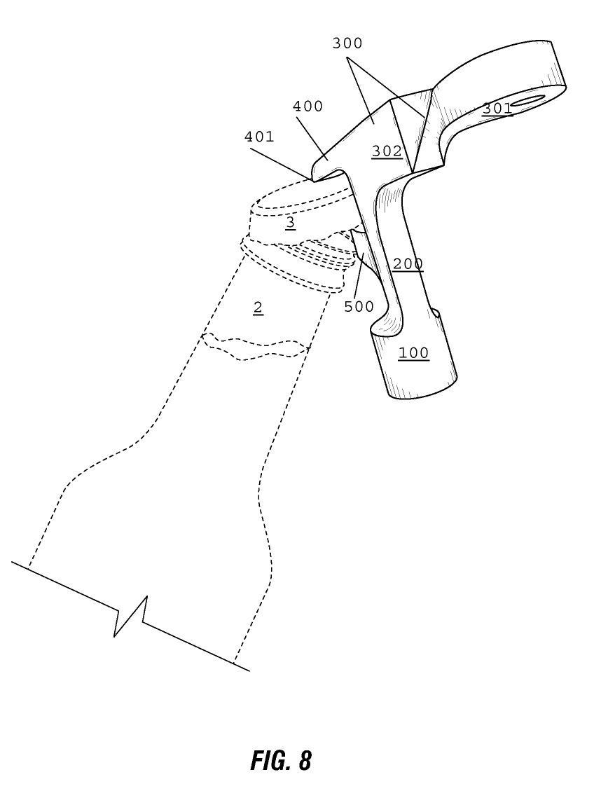

FIG. 8 is an environmental view of the drum key of FIG. 1 being used to open a bottle 2 with a lipped bottle cap 3. As seen in the drawing the cap may be removed as follows. First, the tooth 500 of the drum key may be positioned so that its edge 501 interfaces with a lip of the bottle cap 3. Second, or concurrently with the first step, the fulcrum 401 of the lever 400 may be positioned on top of the cap 3. Third, the lever 400 may be pivoted about the fulcrum 401 so that the edge 501 of the tooth 500 pulls the lip of the cap 3 off of the bottle 2 in the pivot direction.

The drum key 1 may also be used to turn a bolt or screw, e.g., the tension rods of a drum. Operably, the head of the tension rod may be deposited into the pointed recess or socket 101 of the wrench 100 and the wrench may be torqued by moving the handle 300 about the pivot shaft 200.

By way of summary, what is disclosed may be a multi-tasking drum key and related methods. In one non-limiting embodiment, the drum key may comprise: a wrench with a pivot shaft extending therefrom; a handle that forms an elbow with the pivot shaft, wherein the handle has at least one twisted surface; and a lever and tooth on the elbow. Operably, the handle may be used to either (1) turn the wrench about said shaft or (2) pivot the lever on a fulcrum.

In another nonlimiting example, the related methods may include a previously unrealized methods of quenching one's thirst comprising the steps of: locating a wrench with a pivot shaft that is coupled to a handle in the form of an elbow, wherein the handle has a lever extending from the elbow and the pivot shaft has a tooth beneath the lever; locating a drum with a frame, a first tension rod, a second tension rod, a first lug on the frame, and a second lug on the frame; locating a bottled beverage with a lipped cap; turning the wrench about the pivot shaft via the handle to screw the first tension rod into the first lug on the drum frame; positioning the tooth beneath the lip of the bottle cap and pivoting the lever on a fulcrum via the handle to remove the cap; and, turning the wrench about the pivot shaft via the handle to screw the second tension rod into the second lug on the drum frame.

This specification and the appended figures illustrate only typical embodiments or principles disclosed in this application, and therefore, are not to be considered limiting of its scope, for the invention may admit to other equally effective embodiments that will be appreciated by those reasonably skilled in the relevant arts. Any invention disclosed by this specification is defined by the claims.

I claim:

1. A drum key comprising:
a wrench with a pivot shaft;
a handle that forms an elbow with the pivot shaft;
a lever extending from the elbow; and,
a tooth extending from the pivot shaft.

2. The drum key of claim 1 wherein the handle is twisted.

3. The drum key of claim 2 wherein the handle features a key-ring aperture.

4. The drum key of claim 2 wherein the wrench is defined by a pointed recess.

5. The drum key of claim 2 wherein the wrench is defined by an Allen wrench.

6. The drum key of claim 2 wherein the pointed recess has four points.

7. The drum key of claim 1 wherein the handle features at least one surface with first and second portions and configured so that the first portion is oriented perpendicular to the second portion.

8. A drum key comprising:
an elbow;
a lever extending from the elbow; and,
a tooth adjacent to the elbow.

9. The drum key of claim 8 wherein the elbow is at least partially defined by a handle.

10. The drum key of claim 9 wherein the handle is twisted.

11. The drum key of claim 10 wherein the handle features a key-ring aperture.

12. The drum key of claim 10 wherein the wrench is defined by a pointed recess.

13. The drum key of claim 10 wherein the wrench is defined by an Allen wrench.

14. The drum key of claim 10 wherein the pointed recess has four points.

15. The drum key of claim 8 wherein the handle features at least one surface with first and second portions and configured so that the first portion is oriented perpendicular to the second portion.

16. A method of tuning a drum while quenching one's thirst comprising the steps of:
locating a wrench with a pivot shaft that is coupled to a handle in the form of an elbow, wherein the handle has a lever extending from the elbow and the pivot shaft has a tooth beneath the lever;
locating a drum with a frame, a first tension rod, a second tension rod, a first lug on the frame, and a second lug on the frame;
locating a bottled beverage with a lipped cap;
contacting the wrench with the first tension rod;
turning the wrench about the pivot shaft via the handle to screw the first tension rod into the first lug on the drum frame;
positioning the tooth beneath the lip of the bottle cap and pivoting the lever on a fulcrum via the handle to remove the cap;
drinking the beverage;
contacting the wrench with the second tension rod;
and, turning the wrench about the pivot shaft via the handle to screw the second tension rod into the second lug on the drum frame.

17. The method of claim 16 wherein the handle is twisted.

18. The method of claim 17 wherein the handle is coupled to a key ring via an aperture in the handle.

19. The method of claim 18 further comprising the step placing the key-ring and wrench in-pocket.

20. The method of claim 16 wherein the beverage is beer.
